(19) United States
(12) Patent Application Publication
(10) Pub. No.: US 2016/0196272 A1
(43) Pub. Date: Jul. 7, 2016

(54) AUTOMATIC IDENTIFICATION OF MODIFIER TERMS IN A TITLE STRING

(71) Applicant: LinkedIn Corporation, Mountain View, CA (US)

(72) Inventors: Uri Merhav, Rehovot (IL); Vitaly Gordon, Mountain View, CA (US); Kin Fai Kan, Sunnyvale, CA (US)

(21) Appl. No.: 14/588,851

(22) Filed: Jan. 2, 2015

(51) Int. Cl. G06F 17/30; H04L 29/08

(52) U.S. Cl. CPC G06F 17/3061; H04L 67/306; G06Q 50/01

(57) ABSTRACT

A title standardization system may be configured to automatically identify modifier terms in title strings and store these terms in a dictionary for future use. Modifier terms are those phrases in a title string that have been identified as indicative of a certain aspect related to the job of the associated member. In order to identify modifier terms, a title standardization system examines transitions between jobs that the members of the on-line social network system have reported via their respective profiles. If a transition pair comprising a first title string and a second title string was determined to be conforming to a stable pattern, a phrase that is included in the first title string and is lacking from the second title string is identified as a modifier phrase and stored in a dictionary for future use.

### TECHNICAL FIELD

This application relates to the technical fields of software and/or hardware technology and, in one example embodiment, to system and method to automatically identify modifier terms in title strings in an on-line social network system.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to identify modifier terms in title strings may be implemented;

FIG. 2 is block diagram of a system to identify modifier terms in title strings, in accordance with one example embodiment;

FIG. 3 is a flow chart illustrating a method to generate and use a dictionary of modifier terms, in accordance with an example embodiment;

FIG. 4 is a flow chart of further details of a method to identify modifier terms in title strings, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system to identify modifier terms in title strings in an on-line social network is described, In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method describe herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills. Information about a member's professional skills may be referred to as professional attributes. Professional attributes may be maintained in the on-line social network system and may be used in the member profiles to describe and/or highlight professional background of a member. Some examples of professional attributes (also referred to as merely attributes, for the purposes of this description) are strings representing professional skills that may be possessed by a member (e.g., “product management,” “patent prosecution,” “image processing,” etc.). Thus, a member profile may indicate that the member represented by the profile is holding himself out as possessing certain skills.

The profile of a member may also include information about the member's current and past employment, such as company names and professional titles, also referred to as job titles. An on-line social network system may store a great number of raw titles, as members (also referred to as users) may be permitted to input any description into a field (e.g., referred to as a job title field) allocated in their respective member profiles for data that is meant to describe their jobs.

A title string that appears in the job title field in a member profile may include words indicative of various characteristics associated with the job of the member represented by the profile. For example, a title string may include words indicative of job seniority, words indicative of geographic location of the job, etc. Thus, it may be beneficial to have a technique for automatically identifying modifier terms in a title string and storing these terms in a dictionary for future use. A title string may also be referred to as a subject title string as it may be the subject of examination in the process of identifying modifier terms. A system for processing title strings that appear in member profiles in an on-line social network system may also be termed a title standardization system. A title standardization system may be configured to automatically identify modifier terms in title strings (raw or pre-processed) and store these terms in a dictionary for future use, to derive from a title string standardized phrases that describe a member's job, as well as to provide other functionality related to examination and processing of title strings.

Modifier terms are those phrases in a title string that have been identified as indicative of a certain aspect related to the job of the associated member. For example, some modifier terms may provide an indication of the job seniority, such as phrases like “senior,” “assistant,” “intern,” etc. Other modifier terms may be indicative of a geographic location associated with the job (e.g., the phrase “in greater San Francisco” in the title string “software engineer in greater San Francisco”) an industry associated with the job (e.g., the phrase “in the banking sector” in the title string “project manager in the banking sector”) a permanent or temporary nature of the job, etc.

According to one example embodiment, in order to identify modifier terms that may be present in title strings provided in member profiles in an on-line social network system, a title standardization system may leverage so-called transition data. Transition data, in the context of this specification, is information that may be gleaned from a member profile with respect to the member's transition from one professional position to another. Transition data, for the purposes of this description, may be in the form of pairs of title strings, transition pair, where a transition pair includes two title strings (e.g., “software developer” and “senior software developer”). One title string in a transition pair is typically associated with a first time period, while the other title string is associated with a second time period.

In operation, a title standardization system examines transitions between jobs that the members of the on-line social network system have reported via their respective profiles. For example, a member profile may include information indicating that the member represented by the profile transitioned from a position represented by the title “data scientist” to a position represented by the title “senior data scientist” or from a position having the title “manager” to a position represented by the title “regional manager.”

For every transition pair extracted from a sample set of member profiles, a title standardization system determines whether it conforms to a stable pattern across the sample set of member profiles with respect to a potential modifier phrase. Such pattern may indicate that a position represented by title string “X” is typically followed by a position represented by title string “YX” (e.g., the results of examination of transition data extracted from the sample set of data profiles indicates that a position represented by the title “data scientist” is typically followed by a position represented by the title “senior data scientist”). Another pattern may indicate that a position represented by title string “YX” is typically followed by a position represented by title string “X” (e.g., the results of examination of transition data extracted from the sample set of data profiles indicates that a position represented by the title “assistant manager” is typically followed by a position represented by the title “manager”). Yet another pattern may indicate that a position represented by title string “XY” is typically followed by a position represented by title string “X” (e.g., the results of examination of transition data extracted from the sample set of data profiles indicates that a position represented by the title “data scientist intern” is typically followed by a position represented by the title “data scientist”). Yet another pattern may indicate that a position represented by title string “XY” is typically followed by a position represented by title string “X” (e.g., the results of examination of transition data extracted from the sample set of data profiles indicates that a position represented by the title “data scientist intern” is typically followed by a position represented by the title “data scientist”).

In one embodiment, in order to determine whether a transition pair conforms to a stable pattern across the sample set of member profiles, a title standardization system may utilize a model that may be constructed and applied to the member profiles. One of the rules employed by the model may be to infer that a certain transition pattern is a stable pattern if more than or equal to a certain percentage (e.g., 80%) of all transition pairs that are being examined that include a first title string and a second title string are characterized by a certain pattern: e.g., a potential modifier phrase is present in the first title string and is lacking from the second title string or vice versa.

If a transition pair comprising a first title string and a second title string was determined to be conforming to a stable pattern, a phrase that is included in the first title string and is lacking from the second title string is identified as a modifier phrase and stored in a dictionary for future use. A modifier phrase, also referred to as merely a modifier, may include one or more words. A modifier that appears at the beginning of a title string or before the phrase that is included in both title strings in a transition pair may be referred to as a prefix. A modifier that appears at the end of a title string or after the phrase that is included in both title strings in a transition pair may be referred to as a suffix.

A phrase that a title standardization system identified as a modifier may be stored in a dictionary as associated with a category. Examples of a category may be seniority, geographic location, and industry. In one embodiment, a title standardization system may determine that a modifier relates to seniority if more than or equal to a certain percentage of all transition pairs that are being examined that include the modifier are characterized by a pattern, where a position represented by the first title string that includes the modifier is associated with a time period that is less recent than the position represented by the second title string that lacks the modifier, or vice versa. In other words, a title standardization system may determine that, for example, the word “senior” is typically added to a job title that represents a more recent position (people move up in ranks), but is almost never removed from a job title that represents an earlier position. Thus it may be inferred that the word “senior” is indicative of seniority. Similarly, the word “intern” is typically removed from a job title that represents a less recent position, but is almost never added to a job title that represents later position. Some words, like “general,” may be determined to be indicative of seniority consistently in some industries but not so in others. For example the job title “general manager” may signify a more senior position than the job title “manage,” while the job title “general nurse” may not indicate increased seniority as compared to the job title “nurse.”

In one embodiment, a sample set of profiles from the profiles maintained in an on-line network system may be selected based on the associated industry. For example, to determine modifier words for title strings that may be useful in the context of the Internet industry, the transition data may be selected only from the member profiles associated with the Internet industry. To determine modifier words for title strings that may be useful in the context of the banking industry, the transition data may be selected only from the member profiles associated with the banking industry. In other embodiments, the selected sample set of profiles may include all profiles maintained in an on-line network system or a subset of profiles of maintained in an on-line network system selected randomly or based on a predetermined criteria.

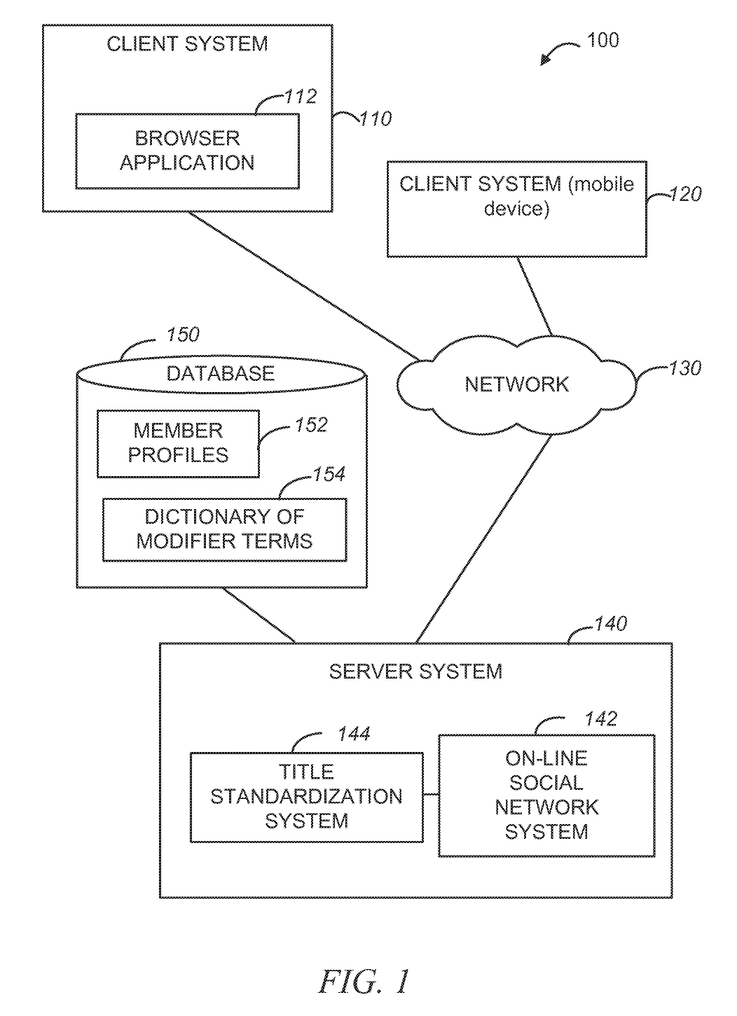

A dictionary of modifier terms may be utilized by a title standardization system during the process of determining a canonical title based on a raw title string. In one embodiment, a title standardization system may be configured to commence the process of determining a canonical title in response to detecting an edit operation associated with the job title field of a member profile. The title standardization system obtains the string from the job title field, identifies what's called a core part of the title string. A core part of the title string is the portion of the subject title string distilled by removing any extraneous words that typically appear at the beginning and/or at the end of a raw title string and are often unrelated to the job function associated with the title but, instead, may be related to seniority, geographic location and, perhaps, company name. The extraneous words that may appear at the beginning of a raw title string are referred to as a prefix. The extraneous words that may appear at the beginning of a raw title string are referred to as a prefix. A title standardization system may examine just the core part of the title string (which may be termed a core title) to derive a canonical title. The derived canonical title may be then associated with the member profile, in which the originally-obtained subject title string was found. This association may be stored in a database for future use, e.g., for targeting job recommendations, recruiting, making professional contacts, as well as for other purposes. In order to determine whether any phrases that appear in the subject string have been previously identified as a prefix or a suffix, the title standardization system may consult a dictionary of modifier terms generated utilized the process described above. An example title standardization system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may he stored in a database 150 as member profiles 152.

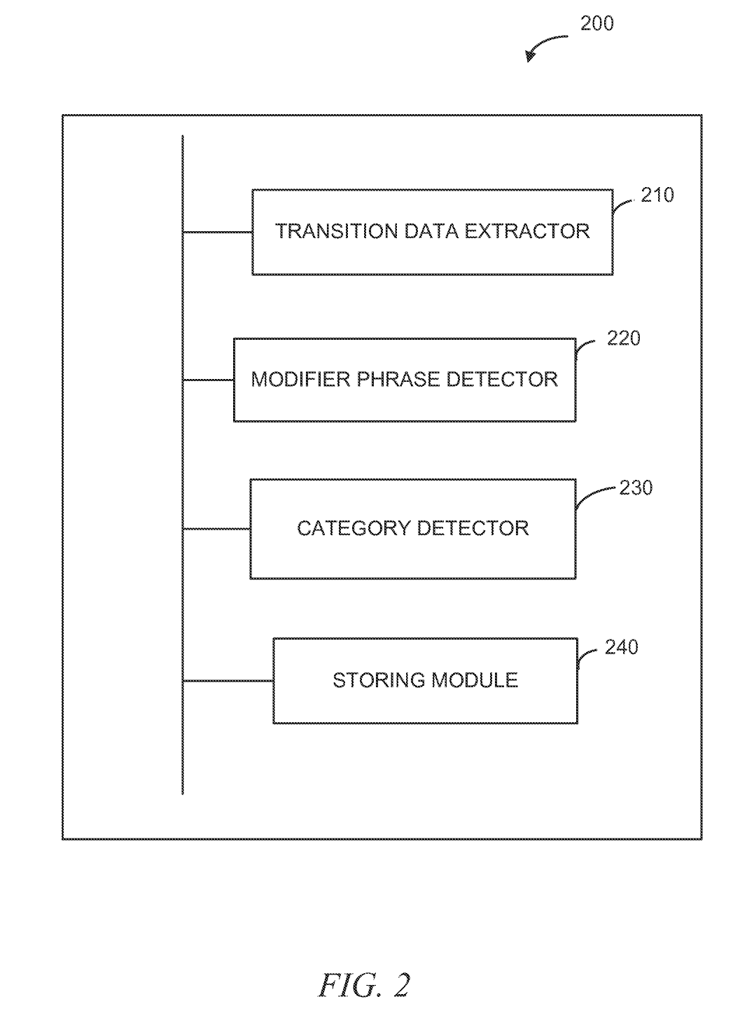

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a title standardization system 144. The title standardization system 144 may be configured to identify modifier terms in title strings stored in the member profiles 152 maintained in the on-line social networking system 142. The dictionary of the modifier terms identified by the title standardization system 144 may be stored in the database 150 as a dictionary of modifier terms 154. The title standardization system 144 may periodically update the dictionary 154. An example title standardization system 144 is illustrated in FIG. 2.

FIG. 2 is a block diagram of a system 200 to identify modifier terms in title strings found in member profiles maintained by the on-line social networking system 142 of FIG. 1. As shown in FIG. 2, the system 200 includes a transition data extractor 210, a modifier phrase detector 220, a category detector 230, and a storing module 240. The transition data extractor 210 may be configured to extract transition data from member profiles maintained in the on-line social network system 142 of FIG. 1. A title string in a member profile from the member profiles represents a professional position of a member represented by the member profile. An item of the transition data comprises a first title string associated with a first time period and a second title string associated with a second time period. The transition data extractor 210 may also be configured to select, from member profiles maintained in the on-line social network system 142 those profiles that are associated with a particular industry and extract transition data only from the member profiles that are associated with the particular industry.

The modifier phrase detector 220 may be configured to identify, in the item of the transition data, a modifier phrase that is included in the second title string and is lacking from the first title string. The modifier phrase detector 220 may also be configured to determine that the item of the transition data conforms to a pattern across a sample set of member profiles from the member profiles with respect to the modifier phrase. Specifically, according to one embodiment, the modifier phrase detector 220 may be configured to identify similar transition pairs from the sample set of member profiles and determine that the similar transition pairs constitute at least a certain percentage of all transition pairs obtained from the sample set of member profiles. Each transition pair from the similar transition pairs comprises one title string that includes the modifier phrase and another title string that lacks the modifier phrase. The category detector 230 may be configured to determine a category related to the modifier phrase. A category may be related to seniority, geographic location, etc.

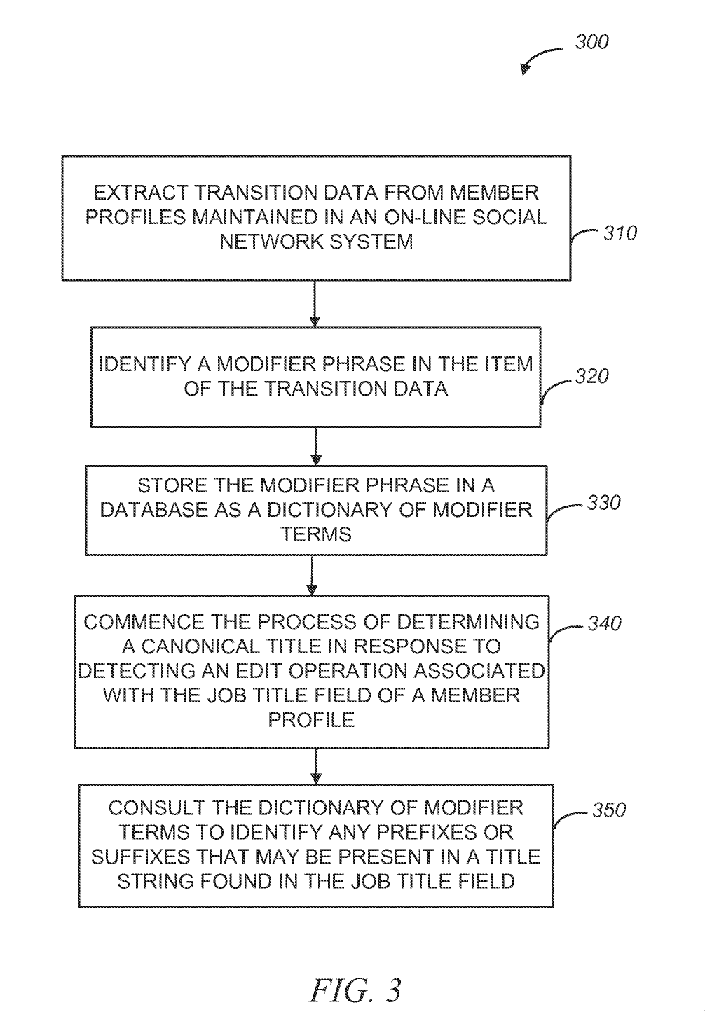

The storing module 240 may be configured to store the modifier phrases in the database 150 of FIG. 1 in the dictionary of modifier terms 154. A modifier phrase may be stored in the dictionary of modifier terms 154 as associated with a particular category. In some embodiments, the storing module 240 may store modifier phrases of different categories in different dictionaries. Some operations performed by the system 200 may be described with reference to FIG. 3.

FIG. 3 is a flow chart of a method 300 to generate and use a dictionary of modifier terms. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the transition data extractor 210 of FIG. 2 extracts transition data from member profiles maintained in the on-line social network system 142 of FIG. 1. At operation 220, the modifier phrase detector 220 of FIG. 2 identifies, in the item of the transition data, a modifier phrase that is included in the second title string and is lacking from the first title string. At operation 230, the storing module 240 of FIG. 2 stores the identified modifier phrases in the database 150 of FIG. 1 in the dictionary of modifier term's 154. At operation 240, the system 200 of FIG. 2 commences the process of determining a canonical title in response to detecting an edit operation associated with the job title field of a member profile. At operation 250, the system 200 consults the dictionary of modifier terms 154 to identify any prefixes or suffixes that may be found in the job title field.

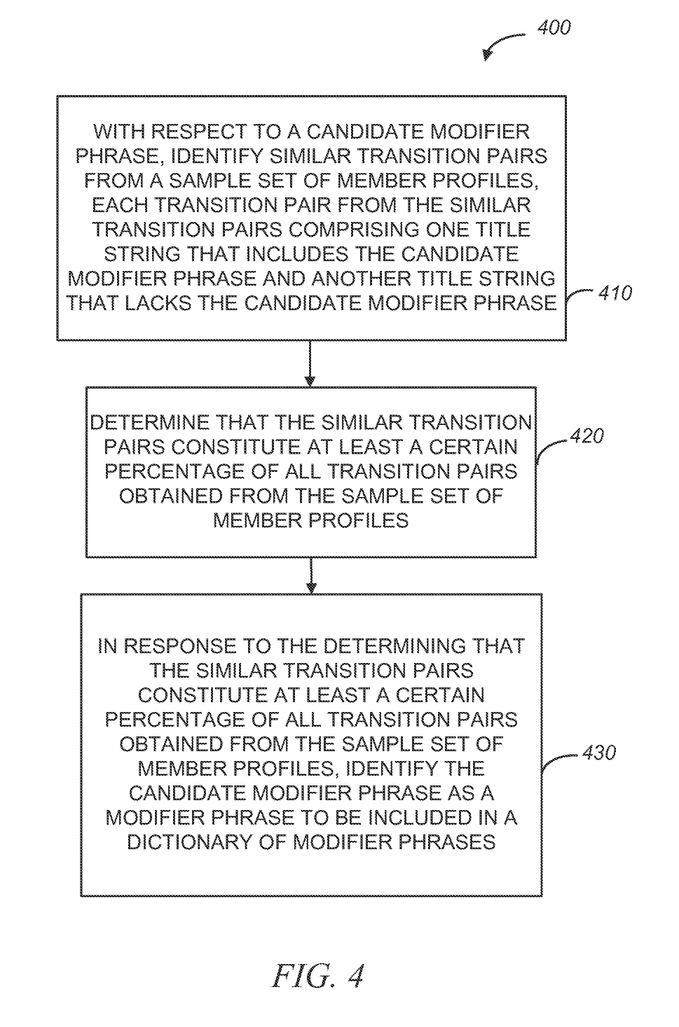

Some further operations that may be performed in the process of identifying modifier terms in title strings may be described with reference to FIG. 4. FIG. 4 is a flow chart of a method 400 that may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 4, the method 400 commences at operation 410, when the modifier phrase detector 220 of FIG. 2, accesses a candidate modifier phrase and identifies, with respect to the candidate modifier phrase, so-called similar transition pairs from a sample set of member profiles. Each transition pair from the similar transition pairs comprises one title string that includes the candidate modifier phrase and another title string that lacks the candidate modifier phrase. At operation 420, the modifier phrase detector 220 determines that the similar transition pairs constitute at least a certain percentage of all transition pairs obtained from the sample set of member profiles. At operation 430, the modifier phrase detector 220, in response to the determining that the similar transition pairs constitute at least a certain percentage of all transition pairs obtained from the sample set of member profiles, identifies the candidate modifier phrase as a modifier phrase to be included in the dictionary of modifier terms 154 of FIG. 1.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

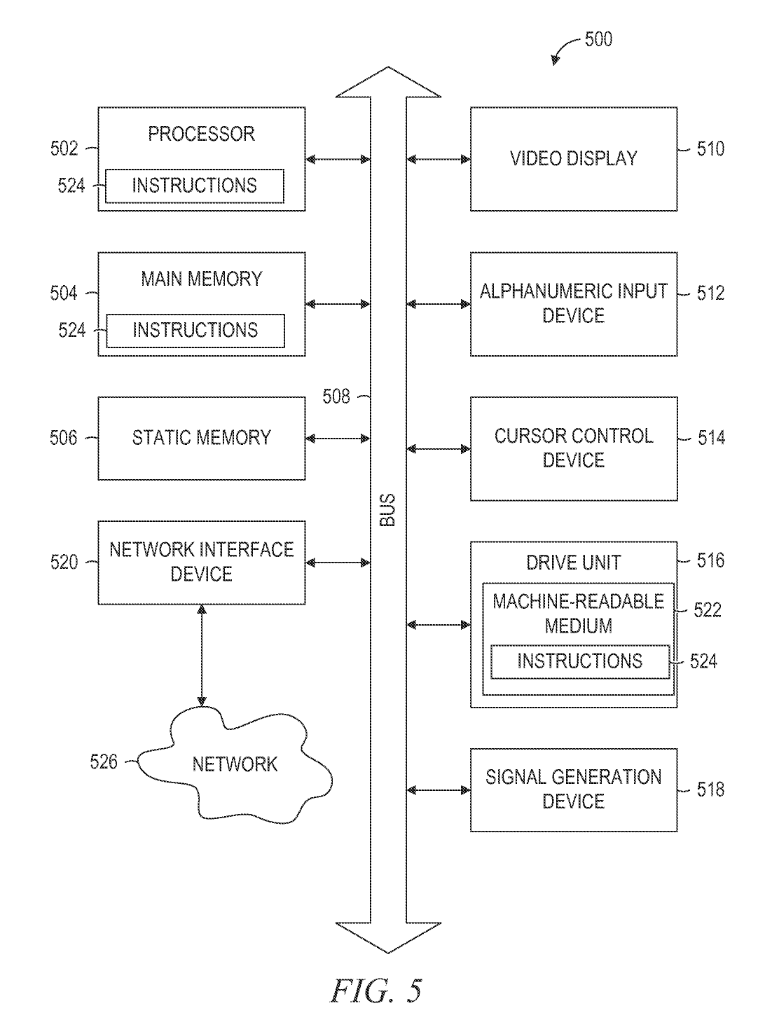

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a borne environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to automatically identify modifier terms in title strings in an on-line social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
extracting transition data from member profiles maintained in an on-line social network system, a title string in a member profile from the member profiles representing a professional position of a member represented by the member profile, an item of the transition data comprising a first title string associated with a first time period and a second title string associated with a second time period;
using at least one processor, identifying a modifier phrase in the item of the transition data, the modifier phrase included in the second title string and lacking from the first title string; and
storing the modifier phrase in a database.

2. The method of claim 1, wherein the identifying of a modifier phrase in the item of the transition data comprises:
determining that the item of the transition data conforms to a pattern across a sample set of member profiles from the member profiles with respect to the modifier phrase.

3. The method of claim 2, wherein the determining that the item of the transition data conforms to a pattern with respect to the modifier phrase comprises:
identifying similar transition pairs from the sample set of member profiles, each transition pair from the similar transition pairs comprising one title string that includes the modifier phrase and another title string that lacks the modifier phrase; and
determining that the similar transition pairs constitute at least a certain percentage of all transition pairs obtained from the sample set of member profiles.

4. The method of claim 3, comprising:
determining a category related to the modifier phrase; and
storing the modifier phrase in the database as associated with the determined category.

5. The method of claim 4, wherein the category is related to geographic location.

6. The method of claim 4, wherein the category is related to professional seniority.

7. The method of claim 6, wherein the category is related to professional seniority, the determining of the category related to the modifier phrase comprising:
determining that, in at least a certain percentage of the similar transition pairs, a title string that includes the modifier phrase is associated with a period of time that is more recent than a period of time associated with a title string that lacks the modifier phrase. [e.g., the word “senior” is almost always added, and the word “intern” is always removed.

8. The method of claim 1, wherein the extracting of the transition data comprises:
selecting, from member profiles maintained in the on-line social network system those profiles that are associated with a particular industry; and
extracting transition data only from the member profiles that are associated with the particular industry.

9. The method of claim 1, wherein the extracting of the transition data comprises:
from the member profiles, extracting title strings, a title string identifying a current professional position of a member represented by the profile; and
from the same profile, extracting a further title string, the further title string representing a previous professional position of the member represented by the profile.

10. The method of claim 1 comprising:
identifying the modifier phrase as a prefix if it appears at the beginning of a title string or before a common phrase that is included in both title strings in the item of the transition data; and
storing the modifier phrase in the database as a prefix.

11. A computer-implemented system comprising:
a transition data extractor, implemented using at least one processor, to extract transition data from member profiles maintained in an on-line social network system, a title string in a member profile from the member profiles representing a professional position of a member represented by the member profile, an item of the transition data comprising a first title string associated with a first time period and a second title string associated with a second time period;
a modifier phrase detector, implemented using at least one processor, to identify a modifier phrase in the item of the transition data, the modifier phrase included in the second title string and lacking from the first title string; and
a storing module, implemented using at least one processor, to store the modifier phrase in a database.

12. The system of claim 11, wherein the modifier phrase detector is to determine that the item of the transition data conforms to a pattern across a sample set of member profiles from the member profiles with respect to the modifier phrase.

13. The system of claim 12, wherein the modifier phrase detector is to:
identify similar transition pairs from the sample set of member profiles, each transition pair from the similar transition pairs comprising one title string that includes the modifier phrase and another title string that lacks the modifier phrase; and
determine that the similar transition pairs constitute at least a certain percentage of all transition pairs obtained from the sample set of member profiles.

14. The system of claim 13, comprising a category detector, implemented using at least one processor, to determine a category related to the modifier phrase, the storing module to store the modifier phrase in the database as associated with the determined category.

15. The system of claim 14, wherein the category is related to geographic location.

16. The system of claim 14, wherein the category is related to professional seniority.

17. The system of claim 16, wherein the category is related to professional seniority, the category detector is to determine that, in at least a certain percentage of the similar transition pairs, a title string that includes the modifier phrase is associated with a period of time that is more recent than a period of time associated with a title string that lacks the modifier phrase.

18. The system of claim 1, wherein the transition data extractor is to:
select, from member profiles maintained in the on-line social network system those profiles that are associated with a particular industry; and
extract transition data only from the member profiles that are associated with the particular industry.

19. The system of claim 1, wherein the transition data extractor is to:
from the member profiles, extract title strings, a title string identifying a current professional position of a member represented by the profile; and
from the same profile, extract a further title string, the further title string representing a previous professional position of the member represented by the profile.

20. A machine-readable non-transitory storage medium having instruction data executable by a machine to cause the machine to perform operations comprising:
extracting transition data from member profiles maintained in an on-line social network system, a title string in a member profile from the member profiles representing a professional position of a member represented by the member profile, an item of the transition data comprising a first title string associated with a first time period and a second title string associated with a second time period;
identifying a modifier phrase in the item of the transition data, the modifier phrase included in the second title string and lacking from the first title string; and
storing the modifier phrase in a database.
